(19) United States
(12) Patent Application Publication
(10) Pub. No.: US 2026/0300495 A1
(43) Pub. Date: Oct. 1, 2026

(54) COMPUTING COMPONENT-BASED SECURITY RISK SCORING

(71) Applicant: Microsoft Technology Licensing, LLC, Redmond, WA (US)

(72) Inventors: Josef WEIZMAN, Petah Tikva (IL); Ram Haim PLISKIN, Tel Aviv (IL); Shay Chriba SAKAZI, Herzliya (IL); Evgeny BOGOKOVSKY, Kfar Saba (IL); Yaron David FRUCHTMANN, Herzliya (IL)

(21) Appl. No.: 19/092,053

(22) Filed: Mar. 27, 2025

(51) Int. Cl. G06F 21/57

(52) U.S. Cl. CPC G06F 21/577; G06F 2221/034

(57) ABSTRACT

A system identifies a security issue instance arising in a computing component of a tenant computing system, assigns a component security issue score to the security issue instance indicating a level of risk of the security issue instance arising from the computing component, and retrieves tenant context scores corresponding to other security issue instances of the security issue type historically arising in computing components of a plurality of other tenant computing systems and representing levels of risk to the plurality of other tenant computing systems by the other security issue instances. The system assigns an imputed tenant context score for the tenant computing system based on the tenant context scores for the plurality of other tenant computing systems and calculates the system security risk score for the tenant computing system for the security issue instance based on modification of the component security issue score using the imputed tenant context score.

### BACKGROUND

Security posture management is a significant part of an organization's security stack. Security posture management has evolved to identify and rate the severity of security issues affecting specific affected computing components and consider other components that may be at risk due to an affected computing component (e.g., an affected computing component's computing context). For example, security posture management may determine how much exposure a computing system as a whole has to the potential adverse effects of a security issue of a computing system component when rating the security issue.

### SUMMARY

In some aspects, the techniques described herein relate to a computer-implemented method of generating a system security risk score representing an impact to a tenant computing system of a security issue instance of a security issue type, the security issue instance arising in a computing component of the tenant computing system, the computer-implemented method including: identifying the security issue instance arising in the computing component of the tenant computing system; assigning a component security issue score to the security issue instance, the component security issue score indicating a level of risk of the security issue instance arising from the computing component; retrieving tenant context scores corresponding to other security issue instances of the security issue type historically arising in computing components of a plurality of other tenant computing systems, the tenant context scores representing levels of risk to the plurality of other tenant computing systems by the other security issue instances of the security issue type, the plurality of other tenant computing systems being different from the tenant computing system; determining an imputed tenant context score for the tenant computing system based on the tenant context scores for the plurality of other tenant computing systems; and calculating the system security risk score for the tenant computing system for the security issue instance based on modification of the component security issue score using the imputed tenant context score.

In some aspects, the techniques described herein relate to one or more tangible processor-readable storage media embodied with instructions for executing on one or more processors and circuits of a computing device a process for generating a system security risk score representing an impact to a tenant computing system of a security issue instance of a security issue type, the security issue instance arising in a computing component of the tenant computing system, the process including: identifying a component security issue score corresponding to a security issue instance, the component security issue score indicating a level of risk of the security issue instance arising from the computing component; retrieving tenant context scores corresponding to other security issue instances of the security issue type historically arising in computing components of a plurality of other tenant computing systems, the tenant context scores representing levels of risk to the plurality of other tenant computing systems by the other security issue instances of the security issue type, the plurality of other tenant computing systems being different from the tenant computing system; determining an imputed tenant context score for the tenant computing system based on the tenant context scores for the plurality of other tenant computing systems; and calculating the system security risk score for the tenant computing system for the security issue instance based on modification of the component security issue score using the imputed tenant context score.

In some aspects, the techniques described herein relate to a computing system for generating a system security risk score representing an impact to a tenant computing system of a security issue instance of a security issue type, the security issue instance arising in a computing component of the tenant computing system, the computing system including: one or more hardware processors; an issue identifier stored in memory and executable by the one or more hardware processors and configured to identify the security issue instance arising in the computing component of the tenant computing system; a component security issue score calculator stored in memory and executable by the one or more hardware processors and configured to assign a component security issue score to the security issue instance, the component security issue score indicating a level of risk of the security issue instance arising from the computing component; a context adjustment calculator stored in memory and executable by the one or more hardware processors and configured to: calculate tenant context scores corresponding to other security issue instances of the security issue type historically arising in computing components of a plurality of other tenant computing systems based on computing contexts of the computing components of the plurality of other tenant computing systems having the other security issue instances, the computing contexts including one or more other computing components of the plurality of other tenant computing systems that are connected to the computing components, the tenant context scores representing levels of risk to the plurality of other tenant computing systems by the other security issue instances of the security issue type, the plurality of other tenant computing systems being different from the tenant computing system; and determine an imputed tenant context score for the tenant computing system based on the tenant context scores for the plurality of other tenant computing systems; and a system security risk score calculator stored in memory and executable by the one or more hardware processors and configured to calculate the system security risk score for the tenant computing system for the security issue instance based on modification of the component security issue score using the imputed tenant context score.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Other implementations are also described and recited herein.

### BRIEF DESCRIPTION OF THE DRAWINGS

FIG. 1 illustrates an example computing environment in which a contextual posture security system determines a system security risk score for a security issue of a target tenant computing system based in part on tenant context scores corresponding to the security issue determined for other tenant computing systems.

FIG. 2 illustrates an example computing environment in which a contextual posture security system determines a component security issue score for a security issue of a computing component of a target tenant computing system (e.g., the affected computing component).

FIG. 3 illustrates an example computing environment in which a contextual posture security system determines a system security risk score for a security issue of a target tenant computing system based in part on tenant context scores corresponding to the security issue determined for other tenant computing systems.

FIG. 4 illustrates examples of operations for generating a system security risk score representing an impact to a tenant computing system of a security issue instance of a security issue type arising in a computing component of the tenant computing system.

FIG. 5 illustrates an example computing device for implementing the described technology.

### DETAILED DESCRIPTION

Security posture management relates to assessing and improving an organization's overall security status and can involve evaluating the security strengths and vulnerabilities across networks, systems, and procedures to ensure robust protection against cyber threats. Elements of security posture management may include, without limitation,
Risk Management: Identifying potential security risks and implementing strategies to mitigate them.
Incident Response: Developing plans and procedures to respond to security breaches or attacks effectively.
Compliance and Governance: Adhering to industry standards, regulations, and laws related to data security.
Security Architecture: Designing and implementing security controls to protect data and resources.
Employee Training and Awareness: Educating employees on security protocols and best practices.

By continuously monitoring and improving these areas, organizations can maintain a strong security posture and better defend against evolving cyber threats.

In one or more implementations of the described technology, security posture management involves determining a component security issue score for a computing component of a target tenant computing system (e.g., corresponding to an organization or one or more users) and then modifying the component security issue score (e.g., using a weighting scheme or other modification) based on the computing context of the computing component to yield a system security risk score for the target tenant computing system. For example, the component security issue score represents the level of risk of the security issue instance arising from the computing component. A target tenant computing system is a tenant computing system for which a security posture management system provides services. Services may include identifying issues in one or more computing components of the target tenant computing system and providing system security risk scores estimating the importance (e.g., the severity, the potential impact, etc.) of such issues. Computing components of a tenant computing system may include physical hardware computing components and/or virtual computing components supported by hardware (e.g., bare machine and/or distributed virtual components). Computing components of a tenant computing system may include but are not limited to, computing components, storage components, network interface components, routers, firewalls, load balancers, memory components, operating system and software components, power systems, cooling systems, input/output components, security and administration components, peripheral components, virtualization and containerization components, or other components of a computing system.

A computing context of a computing component describes the relationship of the computing component to a tenant computing system. For example, the computing context of a computing component may identify other computing components in the tenant computing system to which the computing component is connected via one or more connections. Connections between computing components may include but are not limited to, hardware, physical, logical, software-based, network-based, or other connections between computing components. For example, a security issue instance corresponding to an affected computing component may impact the tenant computing system differently depending on the computing context of the affected computing component. Other factors may be considered part of a computing context in some implementations.

In some approaches, the system security risk score considers the risk exposure of other computing components of the target tenant computing system to the affected computing component. In these approaches, the total system security risk score assigned to a security issue instance of a computing component can be viewed as a combination of a component security issue score (which represents the severity of the security issue as a standalone issue arising from the affected computing component) and a tenant context score, which adjusts the component security issue score based on the computing context of the computing component. For example, if an expired password is detected/identified in the tenant computing system by a security monitoring tool, the total system security risk score assigned to the identified expired password (e.g., the security issue instance) includes a component security issue score modified by a tenant context score, as described below. A security issue instance represents an identified occurrence of a type of security issue in a computing component.

However, significant challenges are present when determining system security risk scores for a target tenant computing system when adequate (or any) computing context information about the target tenant computing system is unavailable to the security posture management system, which may occur in various circumstances exist. In one example situation, the target tenant computing system is not executing software from which the security posture management system can extract context information for the computing components of the target tenant computing system. Therefore, the security posture management system cannot obtain the context information for such computing components. In another example situation, a client (e.g., an operator, an owner, etc. of the target tenant computing system, also referred to as the tenant) associated with the target tenant computing system has not paid for a requisite service tier that enables the sharing of context information with the security posture management system. In yet another example situation, the client does not wish to share such context information with the security posture management (e.g., in response to their own security concerns). Accordingly, in each of these example situations, the tenant computing system does not provide sufficient visibility to computing context information of the security posture management system.

When access to sufficient context information is unavailable (e.g., in the example situations described above), the security posture management system only reports the component security issue score corresponding to a detected issue in a computing component without any context-based adjustment, which is likely to be less accurate than desired. As such, determining and reporting the component security issue score alone may overemphasize or underemphasize the importance or impact of the security issue instance to the target tenant computing system, depending on the computing context of the computing component from which the security issue instance arises. For example, a computing component may have a security issue instance of a severe security issue type, but the computing component is not connected to critical computing components of the target tenant computing system, and reporting the component security issue score alone would, therefore, overemphasize the importance of the security issue instance to the target tenant computing system as a whole. In another example, a computing component may have a security issue instance of a minor security issue type, but the computing component is connected to a critical computing component (e.g., a computing component that stores confidential information), and therefore, reporting the component security issue score would underemphasize the importance of the security issue instance to the target tenant computing system as a whole.

The described technology introduces a security posture management system that can, in the absence of sufficient computing context data for a computing component in the target tenant computing system, determine an imputed tenant context score for an identified security issue instance affecting the computing component based on tenant context scores extracted from other similarly-situated tenant computing systems. The imputed tenant context score is then applied as a modifier to the component security issue score (considered a base score). The other tenant context scores correspond to multiple other tenant computing systems of the security posture management system other than the target tenant computing system. The other tenant computing systems have other security issue instances of the same or similar security issue type as the security issue instance of the component of the target tenant computing system. Accordingly, in some implementations, the security posture management system of the described technology determines an imputed tenant context score derived from the other tenant computing systems with which to modify a component security issue score of a security issue instance detected in the computing component for which context information is unavailable.

Calculating the imputed tenant context score in the described technology may involve determining a representative value (e.g., a statistical value such as, but not limited to, a mean, a median, a mode, or a weighted mean) derived from the other tenant context scores. In some implementations, the described technology may involve filtering the other tenant context scores based on a similarity of the corresponding other tenant computing systems to the target tenant computing system (e.g., tenant computing system size, etc.) or based on a similarity of the affected components of the corresponding other tenant computing systems to the computing component (e.g., component type) and then determining the imputed tenant context score from a filtered subset (e.g., a proper subset) of the other tenant context scores. For example, a proper subset is a subset of the other tenant computing systems that do not include all of the other tenant computing systems.

Accordingly, the described technology's determination and application of an imputed tenant context score for an identified security issue instance of a computing component of a target tenant computing system provides a final system security risk score that better reflects the impact of the identified security issue instance to the target tenant computing system compared to approaches that merely report the component security issue score when context information of the computing component is unavailable or incomplete.

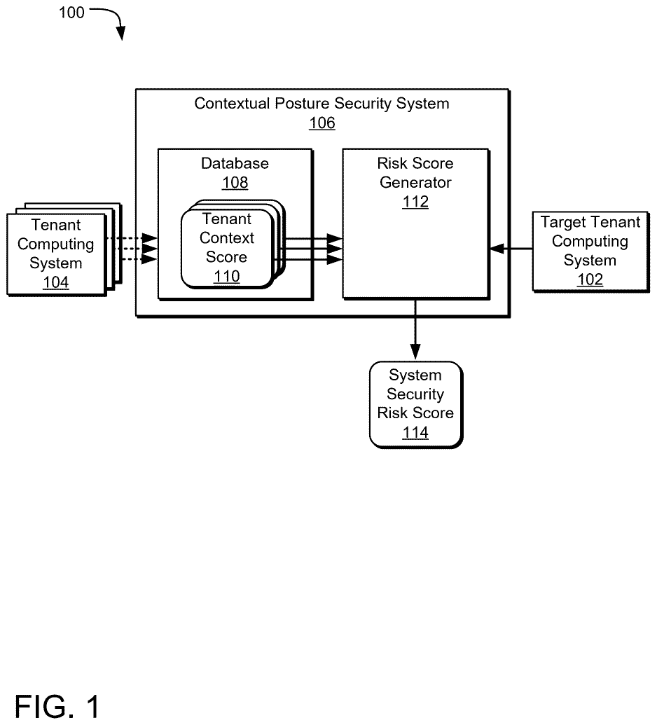

FIG. 1 illustrates an example computing environment 100 in which a contextual posture security system 106 determines a system security risk score 114 for a security issue of a computing system of a target tenant computing system 102 based in part on tenant context scores corresponding to the security issue determined for other tenant computing systems. The computing environment 100 includes the contextual posture security system 106 and tenant computing systems of the contextual posture security system 106, including the target tenant computing system 102 (e.g., the tenant computing system for which a system security risk score 114 is determined) and one or more other tenant computing systems (e.g., tenant computing system 104) other than the target tenant computing system 102.

The tenant computing systems (including the target tenant computing system 102 and other tenant computing systems) may be computing systems having large computing environments that include many computer networks. Tenant computing systems include one or more computing components connected via one or more connections. Computing components of a tenant computing system may include, but are not limited to, computing components (e.g., central processing units (CPUs), graphics processing units (GPUs), Virtual Machines, cloud instances, etc.), storage components (e.g., hard drives, solid state drives (SSDs), cloud storage, etc.), network interface components (e.g., network interface cards (NICs), routers, firewalls, load balancers, etc.), memory components (e.g., random access memory (RAM), cache memory, etc.), operating system and software components (e.g., system software, drivers, etc.), power systems (e.g., power supply units, uninterruptible power supply (UPS), etc.), cooling systems (e.g., fans, liquid cooling systems, etc.), input/output components (e.g., keyboards, monitors, printers, universal serial bus (USB) devices, etc.), security and administration components (e.g., authentication systems, encryption modules, multifactor authentication (MFA) tools, etc.), peripheral components (e.g., expansion cards, external storage devices, docking stations, etc.), virtualization and containerization components (e.g., hypervisors, etc.), or other components of a computing system. Computing components may include, but are not limited to, computers, mobile devices, power supplies, storage devices, databases, routers, firewalls, Wi-Fi access points, modems, smart speakers, and smart televisions. Connections between the computing components may include but are not limited to, hardware, physical, logical, software-based, network-based, or other connections between the computing components. For example, a security issue corresponding to an affected computing component may impact the computing system differently depending on the computing context of the affected computing component.

The contextual posture security system 106 is a computing system that provides security posture management services for tenant computing systems of the contextual posture security system 106. Security posture management services may include detecting a security issue (e.g., a security vulnerability) and estimating the severity of the security issue for a target tenant computing system 102, which may include determining a component security issue score representing the severity of the security issue to the affected computing component of the target tenant computing system 102 and determining a system security risk score 114 representing a severity of the security issue to the computing system of the target tenant computing system 102. For example, the detected security issue is a security issue instance. The security issue instance also corresponds to a security issue type. The severity of a security issue instance refers to the level of impact and risk it poses to the affected computing component (e.g., the component security issue score) and to the computing system of the target tenant computing system 102. Estimating the severity of a security issue instance involves estimating the severity of the security issue type. Providing scores to represent the severity may aid in prioritizing security issues and determining the urgency of addressing them. In some implementations, the risk score generator 112 accesses, in the database 108, a component security issue score corresponding to the security issue type of the identified security issue instance. Security issue types represent categories corresponding to security issue instances. For example, security issue types may include but are not limited to, security misconfigurations, unpatched software, weak or default credentials, weak login mechanisms, accepting unvalidated inputs, insecure application programming interfaces (APIs), insecure file uploads, lack of data encryption, open ports, and services, insecure cloud configurations, overprivileged permissions, improper management of cryptographic keys or credentials, unrestricted or under-restricted network access, a lack of logging and monitoring, or other security issues that may expose a system to attack, data loss, exposure of confidential data, outages, or other undesired outcomes.

The contextual posture security system 106 includes a risk score generator 112 and a database 108. The risk score generator 112 determines a system security risk score 114, representing the severity of a detected security issue instance to the target tenant computing system 102 of an affected computing component of the target tenant computing system 102. To determine the system security risk score 114, the risk score generator 112 may determine a component security issue score representing the severity of the security issue instance to the affected computing component and then modify the component security issue score using an imputed context score to determine the system security risk score 114. The system security risk score 114 represents a severity of the security score to the target tenant computing system 102. Determining the component security issue score may include accessing the component security issue score in the database 108, the component security issue score corresponding to the security issue type of the security issue instance. Within the database 108, the component security issue score may be associated (e.g., using a table or other data structure) with an identifier corresponding to the security issue type. In some examples, the component security issue score is associated with the identifier corresponding to the security issue type and an identifier corresponding to the type of the affected computing component (e.g., a component type). For example, the contextual posture security system 106 identifies the security issue type of the security issue instance of the affected computing component of the computing system of the target tenant computing system 102 and then identifies (e.g., looks up in the table or other data structure) the component security issue score using the security issue type identifier corresponding to the detected security issue instance and/or the component type identifier corresponding to the type of the computing component.

Determining the imputed tenant context score may include accessing (e.g., from the database 108) a set of tenant context scores (e.g., the tenant context score 110) associated with other tenant computing systems (e.g., the tenant computing system 104). The tenant context scores are scores used to modify, for the other tenant computing systems, component security issue scores corresponding to the same security issue type as the security issue instance of the affected computing component of the target tenant computing system 102. For example, tenant context scores may be associated in a table (or other data structure) with tenant computing system identifiers identifying the corresponding tenant computing systems and an identifier corresponding to the security issue type.

The tenant context scores used to derive the imputed tenant context score are determined based on corresponding computing contexts of the affected computing components of the other tenant computing systems (e.g., the tenant computing system 104). For example, the values of the tenant context scores (e.g., the tenant context score 110) may vary for the other tenant computing systems (e.g., the tenant computing system 104) according to the specific computing contexts of the other tenant computing systems. For example, the tenant context score may be more significant for computing contexts in which a greater number of computing components are connected to (e.g., physically, logically, or otherwise connected to) the affected computing component than for computing contexts in which a lesser number of computing components are connected to the affected computing component. In some implementations, the tenant context score may consider the number of primary connections (e.g., a number of computing components connected directly to the affected computing component), a number of secondary connections (e.g., a secondary computing component connected to a primary computing component that is connected to the affected computing component), and so forth (e.g., tertiary connections, etc.). In some implementations, the computing context may be a weighted number of connections to the connected component. For example, the risk score generator 112 may, in some implementations, weight primary connections greater than secondary connections and secondary connections greater than tertiary connections when calculating the number of connections. In some implementations, the number of connections may be modified by weighting connections based on the security characteristics of the connected components. For example, the security characteristics may include a type of computing component, a sensitivity of the computing component, security measures implemented on the computing component, or other security characteristics. For example, the number of connections may be modified by weighting connections corresponding to sensitive types of computing components (e.g., components storing sensitive data, components having internet access, etc.) greater than connections corresponding to less sensitive types of computing components (e.g., a display monitor). In some implementations, the number of connections may be modified by weighting connections corresponding to computing components implementing a lesser degree of security measures (e.g., a simple username/password) greater than connections corresponding to computing components implementing a greater degree of security measures (e.g., multifactor authentication).

Determining the imputed tenant context score may include determining an average, a median, a weighted average, a mode, or other statistic or representative value for the set of tenant context scores (e.g., the tenant context score 110). Determining the imputed tenant context score may be determined as a function of the set of tenant context scores. In some implementations, the imputed tenant context score is imputed to the target tenant computing system 102 because the computing context (e.g., computing components and their connections to each other within the computing system) of the affected computing component of the target tenant computing system 102 is unknown. For example, responsive to determining that the computing context of the affected computing component of the target tenant computing system 102 is unknown, the risk score generator determines the system security risk score 114 based at least in part on a component security issue score determined for the security issue of the affected computing component of the target tenant computing system 102 and the set of tenant context scores (e.g., the tenant context score 110) determined for other tenant computing systems (e.g., a plurality of other tenant computing systems including the tenant computing system 104) having affected computing components having other security instances of the same security issue type as the security issue instance of the affected component of the target tenant computing system 102. In this example, responsive to determining that the computing context of the affected computing component of the target tenant computing system 102 is known, the risk score generator 112 determines the system security risk score 114 based at least in part on a component security issue score determined for the security issue instance of the affected computing component of the target tenant computing system 102 and a tenant context score determined from the computing context of the affected computing component.

To determine the system security risk score 114, the risk score generator 112 may modify the component security issue score (e.g., representing the severity of the security issue instance to the affected computing component) using the imputed tenant context score to determine the system security risk score 114 (e.g., which represents the severity of the security score to the computing system of the target tenant computing system 102). For example, the risk score generator 112 may add the imputed tenant context score (e.g., a positive or negative value) to the component security issue score to determine the system security risk score 114. In some implementations, the risk score generator 112 may multiply the component security issue score by the imputed tenant context score to determine the system security risk score 114 or may otherwise determine the system security risk score 114 by applying a scoring algorithm to the component security issue score and the imputed tenant context score.

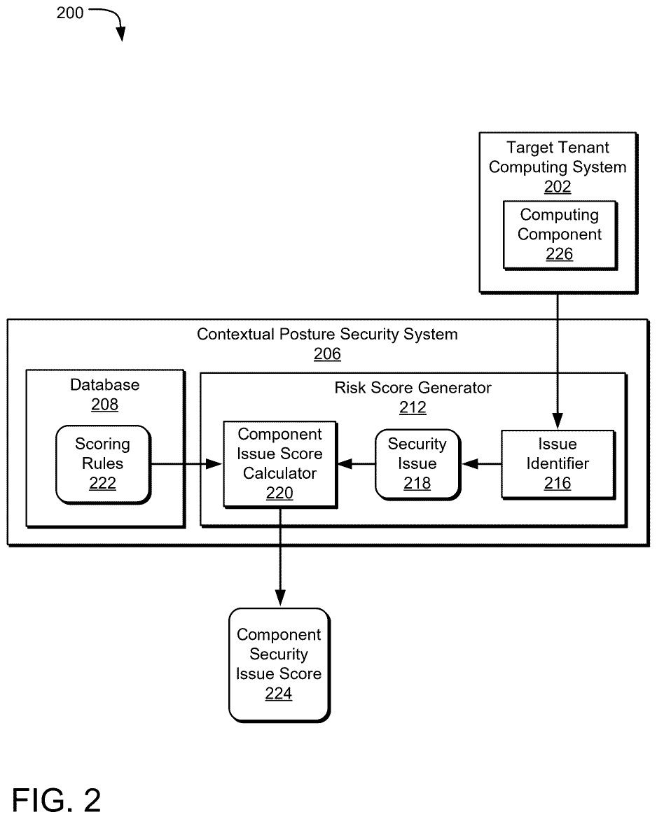

FIG. 2 illustrates an example computing environment 200 in which a contextual posture security system 206 determines a component security issue score 224 for a security issue of a computing component 226 of a target tenant computing system 202 (e.g., the affected computing component). The computing environment 200 includes the contextual posture security system 206 and one or more tenant computing systems, including the target tenant computing system 202.

The contextual posture security system 206 includes a risk score generator 212 and a database 208. The risk score generator 212 includes an issue identifier 216 and a component security issue score calculator 220. The issue identifier 216 identifies a security issue 218 (e.g., a security issue instance) arising in the computing component 226 of the target tenant computing system 202. In some implementations, the issue identifier 216 monitors, scans, or otherwise analyses the target tenant computing system 202 and detects the security issue 218 arising in the computing component 226. In some implementations, the issue identifier 216 receives an identification of the security issue 218 from the target tenant computing system 202 or from another computing system that identifies the security issue of the computing component 226.

The component security issue score calculator 220 determines a component security issue score 224 representing the severity of a detected security issue to the computing component 226 of the computing system of the target tenant computing system 202. In some implementations, the component security issue score calculator 220 determines the component security issue score 224 corresponding to a security issue type of the security issue 218 in accordance with scoring rules 222. For example, the scoring rules 222 are stored in the database 208 and associate a set of component security issue scores with a corresponding set of security issue types. For example, the scoring rules 222 associate (e.g., in a table or other data structure) the set of scores with a security issue type identifier of a corresponding security issue type. The component security issue score calculator 220 determines a security issue type identifier corresponding to the security issue 218 and then identifies, in the scoring rules 222, the component security issue score 224 corresponding to the security issue type identifier (e.g., a many-to-one relationship).

Determining the component security issue score 224 may include accessing the component security issue score in the database 208, the component security issue score 224 corresponding to the security issue type of the security issue instance. An operator of the contextual posture security system 206 may configure a range for component security issue scores (e.g., 0-10, 0-100, or other predetermined range) and assign component security issue scores for security issue types. For example, a lesser component security issue score indicates a lesser severity of the security issue type and a greater component security issue score indicates a greater severity of the security issue type. Within the database 208, the component security issue score 224 may be associated (e.g., using a table or other data structure) with an identifier corresponding to the security issue type. In some examples, the component security issue score 224 is associated with the identifier corresponding to the security issue type and an identifier corresponding to the type of the affected computing component 226 (e.g., a component type). For example, the contextual posture security system 106 identifies the security issue type of the security issue instance of the affected computing component of the computing system of the target tenant computing system 102 and then identifies (e.g., looks up in the table or other data structure) the component security issue score 224 using the security issue type identifier corresponding to the detected security issue 218 and/or the component type identifier corresponding to the type of the computing component.

In some examples, the component security issue score 224 is associated with the scoring rules 222, with the security issue type identifier and an identifier corresponding to the type of the computing component 226 (e.g., a component type identifier). For example, the issue identifier 216 identifies the security issue 218 of the computing component 226 of the target tenant computing system 202 and a security issue type of the security issue 218. The component security issue score calculator 220 determines (e.g., looks up in the table or other data structure specified in the scoring rules 222) the component security issue score 224 using the security issue type identifier and/or the component type identifier corresponding to the type of the computing component 226.

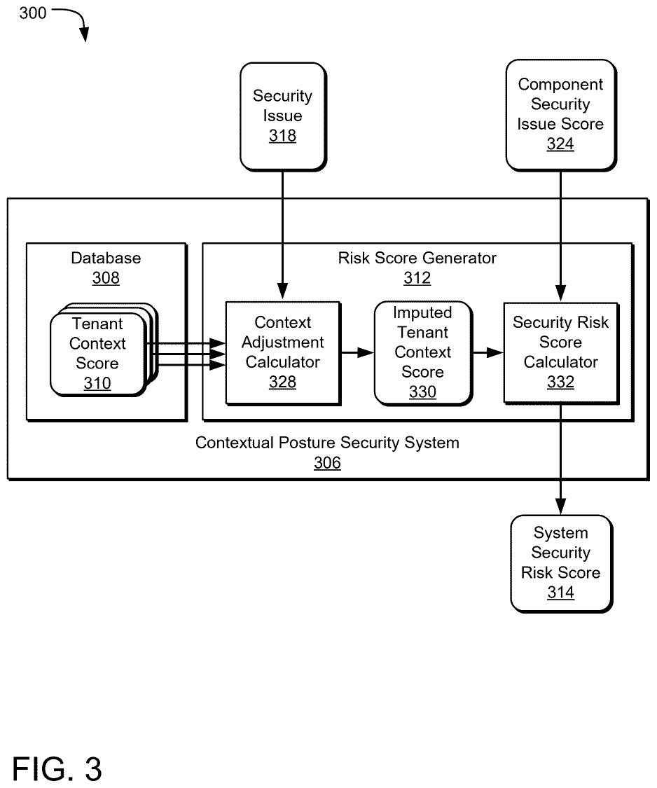

FIG. 3 illustrates an example computing environment 300 in which a contextual posture security system 306 determines a system security risk score 314 for a security issue 318 of a computing system of a target tenant computing system based in part on tenant context scores corresponding to the security issue determined for other tenant computing systems. The computing environment 300 includes the contextual posture security system 306. The contextual posture security system 306 includes the risk score generator 312 and the database 308.

The risk score generator 312 includes a context adjustment calculator 328 and a security risk score calculator 332. The security risk score calculator 332 accesses or otherwise receives the component security issue score 324, representing the severity of the security issue 318 (e.g., a security issue instance) to an affected computing component of a target tenant computing system. The component security issue score 324 represents the severity of the security issue 318 to the affected computing component. The security risk score calculator 332 modifies the component security issue score 324 using an imputed tenant context score 330 to determine the system security risk score 314. The system security risk score 314 represents the severity of the security issue 318 to the target tenant computing system.

The context adjustment calculator 328 receives the security issue 318 or otherwise identifies the security issue 318 determined by an issue identifier of the contextual posture security system 306. The context adjustment calculator 328 determines the imputed tenant context score 330 based on a security issue type of the security issue 318 and a set of tenant context scores (e.g., the tenant context score 310). Determining the imputed tenant context score 330 may include accessing (e.g., from the database 308) a set of tenant context scores (e.g., the tenant context score 310) associated with other tenant computing systems. For example, the other tenant computing systems are tenant computing systems of the contextual posture security system 306 other than the target tenant computing system for which system security risk scores (e.g., system security risk score 314) are determined. The set of tenant context scores (e.g., the tenant context score 310) was determined for the corresponding other tenant computing systems and were used to modify (e.g., to increase, decrease, multiply, divide, or otherwise modify) component security issue scores corresponding to security issue instances of the same security issue type as the security issue instance of the affected computing component of the target tenant computing system. For example, the tenant context scores (e.g., tenant context score 310) may be associated in a table (or other data structure) with tenant computing system identifiers identifying the corresponding other tenant computing systems and a security issue type identifiers corresponding to the security issue type of the security issue 318.

The context scores (e.g., the tenant context score 310) are determined based on a corresponding computing context to the affected computing components of the other tenant computing systems. For example, the values of the tenant context scores (e.g., the tenant context score 310) may vary for the other tenant computing systems according to the specific computing context of the other tenant computing systems. For example, a tenant context score (e.g., the tenant context score 310) may be greater for computing contexts in which a greater number of computing components are connected to (e.g., physically, logically, or otherwise connected to) the affected computing component than for computing contexts in which a lesser number of computing components are connected to the affected computing component. In some implementations, the tenant context score may vary based on the number of primary connections (e.g., a number of computing components connected directly to the affected computing component), the number of secondary connections (e.g., a secondary computing component connected to a primary computing component that is connected to the affected computing component), and so forth (e.g., tertiary connections, etc.). In some implementations, the computing context may be a weighted number of connections to the connected computing component. For example, in some implementations, primary connections may be weighted greater than secondary connections and secondary connections greater than tertiary connections when calculating the number of connections. In some implementations, the number of connections may be modified by weighting connections corresponding to sensitive types of computing components (e.g., secure element data storage of sensitive data) greater than connections corresponding to less sensitive types of computing components (e.g., a display monitor). An operator of the contextual posture security system 306 may configure a range for tenant context scores (e.g., 0-10, 0-100, or other predetermined range) and may calculate the tenant context scores within the configured range. A lesser tenant context score may indicate a lesser impact of security issue instances of a computing component to a corresponding other tenant computing system and a greater tenant context score may indicate a greater impact of security issue instances of the computing component to the corresponding other tenant computing system. Within the database 308, the tenant context scores may be associated (e.g., using a table or other data structure) with identifiers corresponding to the other tenant computing systems and identifiers corresponding to the security issue types that indicate the security issue types for which the tenant context scores were determined. For example, the contextual posture security system 306 identifies the security issue type of the security issue instance of the affected computing component of the target tenant computing system and then identifies (e.g., looks up in the table or other data structure) the tenant context scores from the database 308 corresponding to the same security issue type. The contextual posture security system 306 calculates the imputed tenant context score from the identified context scores.

The context adjustment calculator 328 determines the imputed tenant context score 330. For example, the context adjustment calculator 328 may determine an average, a median, a weighted average, a mode, or other statistic or representative value for the identified tenant context scores (e.g., the tenant context score 310). In some implementations, the context adjustment calculator 328 imputes the imputed tenant context score 330 to the target tenant computing system because the computing context (e.g., computing components and their connections to each other within the computing system) of the affected computing component of the target tenant computing system is unknown. Accordingly, the imputed tenant context score 330, which is based on the tenant context scores (e.g., tenant context score 310) determined for the other tenant computing systems, is imputed because it stands in the place of a context score that is not determinable for the target tenant computing system. For example, responsive to determining that the computing context of the affected computing component of the target tenant computing system is unknown, the risk score generator determines the imputed tenant context score 330. In some implementations, responsive to determining that the computing context of the affected computing component of the target tenant computing system is known, the context adjustment calculator 328 determines a context score for the target tenant computing system based on the known computing context of the target tenant computing system.

To determine the system security risk score 314, the security risk score calculator 332 may modify the component security issue score 324 (e.g., representing the severity of the security issue to the affected computing component) using the imputed tenant context score 330 (or in some implementations, the context score determined for the target tenant computing system) to determine the system security risk score 314. The system security risk score 314 represents the severity of the security score to the computing system of the target tenant computing system. For example, the security risk score calculator 332 may add the imputed tenant context score 330 (e.g., a positive or negative value) to the component security issue score 324 to determine the system security risk score 314. In some implementations, the security risk score calculator 332 may multiply the component security issue score 324 by the imputed tenant context score 330 to determine the system security risk score 314 or may otherwise determine the system security risk score 314 by applying a scoring algorithm to the component security issue score 324 and the imputed tenant context score 330.

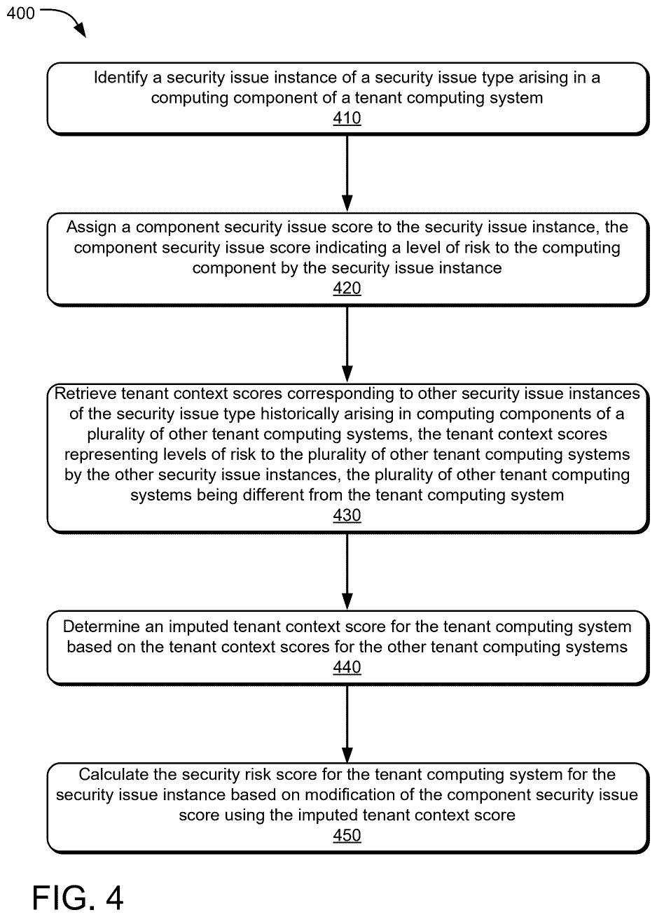

FIG. 4 illustrates examples of operations 400 for generating a system security risk score representing an impact to a tenant computing system of a security issue instance of a security issue type arising in a computing component of the tenant computing system.

An identifying operation 410 identifies the security issue instance of the security issue type arising in the computing component of the tenant computing system.

An assigning operation 420 assigns a component security issue score to the security issue instance, the component security issue score indicating a level of risk to the computing component by the security issue instance.

A retrieving operation 430 retrieves tenant context scores corresponding to other security issue instances of the security issue type historically arising in computing components of a plurality of other tenant computing systems, the tenant context scores representing levels of risk to the plurality of other tenant computing systems by the other security issue instances of the security issue type, the other tenant computing systems being different from the tenant computing system. In some implementations, the tenant context scores are calculated based on computing contexts of the components of the other tenant computing systems having the other security issue instances of the security issue type, the computing contexts including one or more other computing components of the other tenant computing systems that are connected to the computing components. In some implementations, the one or more other computing components are one or more of logically connected or physically connected to the computing components.

A determining operation 440 determines an imputed tenant context score for the tenant computing system based on the tenant context scores for the other tenant computing systems.

A calculating operation 450 calculates the system security risk score for the tenant computing system for the security issue instance based on modification of the component security issue score using the imputed tenant context score. In some implementations, the modification of the component security issue score by the imputed context score includes summing the component security issue score and the imputed context score. In some implementations, the imputed context score is an average of the tenant context scores. In some implementations, the tenant context scores are filtered to yield a set of filtered tenant context scores, wherein filtering the tenant context scores includes removing a subset (e.g., removing a proper subset) of the tenant context scores determined for the other security issue instances identified for computing components of one or more different computing component types from the computing component type of the computing component, wherein the system security risk score is calculated based on the set of filtered tenant context scores. For example, the tenant context scores corresponding to the other tenant computing systems may be associated with component types, and filtering the tenant scores may involve removing tenant context scores that are not associated with the same component type as the component of the target tenant computing system from which the security issue instance arises. Filtering the tenant context scores ensures that the imputed context score is calculated from a subset of the tenant context scores corresponding to other tenant computing systems having computing components from which the corresponding security instances arise that have similar characteristics to the computing component of the target tenant computing system. Accordingly, filtering the tenant context scores in this manner may increase the accuracy of the imputed tenant context score compared to calculating the imputed tenant context score from the full set of target context scores.

In some implementations, the tenant context scores are filtered to yield a set of filtered tenant context scores, wherein filtering the tenant context scores comprises removing a subset (e.g., a proper subset) of the tenant context scores corresponding to a subset (e.g., a proper subset) of the other tenant computing systems of a different type from the tenant computing system, wherein the system security risk score is calculated based on the set of filtered tenant context scores. For example, the tenant context scores corresponding to the other tenant computing systems may be associated with entity types and filtering the tenant scores may involve removing tenant context scores that are not associated with the same entity type as the target tenant computing system from which the security issue instance arises. For example, entity types may include small entity, security service entity, payment processing entity, or other entity types that describes characteristics of the target tenant computing system and/or the other tenant computing systems. Filtering the tenant context scores ensures that the imputed context score is calculated from a subset of the tenant context scores corresponding to other tenant computing systems that have similar characteristics to the target tenant computing system. Accordingly, filtering the tenant context scores in this manner may increase the accuracy of the imputed tenant context score compared to calculating the imputed tenant context score from the full set of target context scores.

In some implementations, a computing context of the tenant computing system is determined to be unknown, wherein the computing context is determined based on a number of other computing components that are connected to the computing component and security characteristics of the number of other computing components, wherein retrieving, determining, and calculating are performed responsive to determining that the computing context of the tenant computing system is unknown.

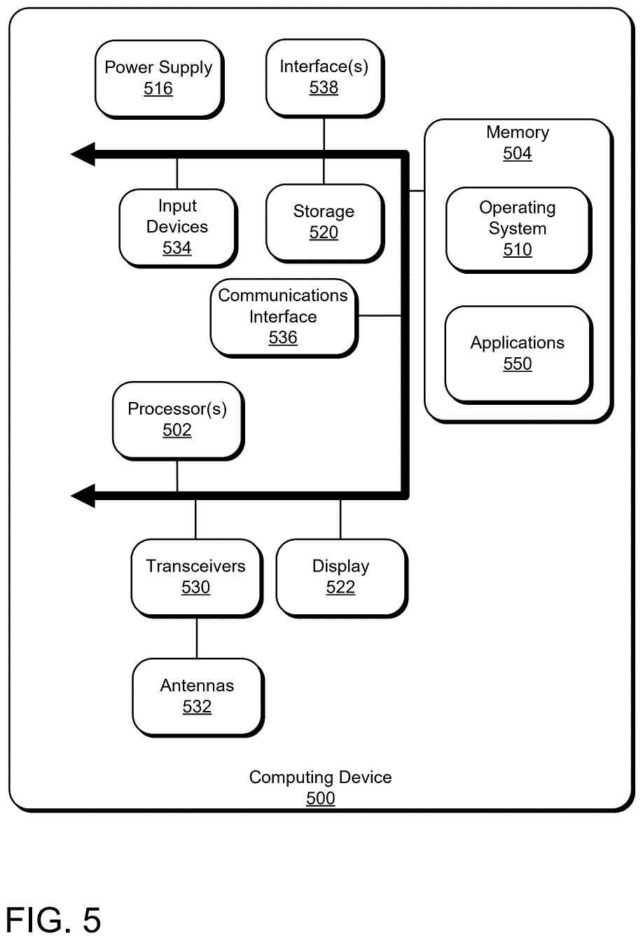

FIG. 5 illustrates an example computing device 500 for implementing the described technology. The computing device 500 may be a client computing device (such as a laptop computer, a desktop computer, or a tablet computer), a server/cloud computing device, an Internet-of-Things (IoT), any other type of computing device, or a combination of these options. The computing device 500 includes one or more hardware processor(s) 502 and a memory 504. The memory 504 generally includes both volatile memory (e.g., RAM) and nonvolatile memory (e.g., flash memory), although one or the other type of memory may be omitted. An operating system 510 resides in the memory 504 and is executed by the processor(s) 502. In some implementations, the computing device 500 includes and/or is communicatively coupled to storage 520.

In the example computing device 500, as shown in FIG. 5, one or more software modules, segments, and/or processors, such as one or more of a contextual posture security system, a risk score generator, a database, tenant computing systems, a target tenant computing system, affected computing components, an issue identifier, a component security issue score calculator, an impact score calculator, a context adjustment calculator, applications 550, and other program code and modules are loaded into the operating system 510 on the memory 504 and/or the storage 520 and executed by the processor(s) 502. The storage 520 may store data (e.g., including one or more context scores, system security risk scores, security issue identifiers, scoring rules, component security issue scores, imputed context scores, or other data) and be local to the computing device 500 or may be remote and communicatively connected to the computing device 500. In particular, in one implementation, components of a system for determining a system security risk score for a security issue of a computing system of a target tenant computing system based in part on context scores corresponding to the security issue determined for other tenant computing systems may be implemented entirely in hardware or in a combination of hardware circuitry and software.

The computing device 500 includes a power supply 516, which may include or be connected to one or more batteries or other power sources and which provides power to other components of the computing device 500. The power supply 516 may also be connected to an external power source that overrides or recharges the built-in batteries or other power sources.

The computing device 500 may include one or more communication transceivers 530, which may be connected to one or more antenna(s) 532 to provide network connectivity (e.g., mobile phone network, Wi-Fi®, Bluetooth®) to one or more other servers, client devices, IoT devices, and other computing and communications devices. The computing device 500 may further include a communications interface 536 (such as a network adapter or an I/O port, which are types of communication devices). The computing device 500 may use the adapter and any other types of communication devices for establishing connections over a wide-area network (WAN) or local-area network (LAN). It should be appreciated that the network connections shown are exemplary and that other communications devices and means for establishing a communications link between the computing device 500 and other devices may be used.

The computing device 500 may include one or more input devices 534 such that a user may enter commands and information (e.g., a keyboard, trackpad, or mouse). These and other input devices may be coupled to the server by one or more interfaces 538, such as a serial port interface, parallel port, or universal serial bus (USB). The computing device 500 may further include a display 522, such as a touchscreen display.

The computing device 500 may include a variety of tangible processor-readable storage media and intangible processor-readable communication signals. Tangible processor-readable storage can be embodied by any available media that can be accessed by the computing device 500 and can include both volatile and nonvolatile storage media and removable and non-removable storage media. Tangible processor-readable storage media excludes intangible, transitory communications signals (such as signals per se) and includes volatile and nonvolatile, removable, and non-removable storage media implemented in any method, process, or technology for storage of information such as processor-readable instructions, data structures, program modules, or other data. Tangible processor-readable storage media includes but is not limited to, RAM, ROM, EEPROM, flash memory or other memory technology, CDROM, digital versatile disks (DVD) or other optical disk storage, magnetic cassettes, magnetic tape, magnetic disk storage, or other magnetic storage devices, or any other tangible medium which can be used to store the desired information and which can be accessed by the computing device 500. In contrast to tangible processor-readable storage media, intangible processor-readable communication signals may embody processor-readable instructions, data structures, program modules, or other data resident in a modulated data signal, such as a carrier wave or other signal transport mechanism. The term “modulated data signal” means a signal that has one or more of its characteristics set or changed in such a manner as to encode information in the signal. By way of example, and not limitation, intangible communication signals include signals traveling through wired media such as a wired network or direct-wired connection, and wireless media such as acoustic, RF, infrared, and other wireless media.
Clause 1. A computer-implemented method of generating a system security risk score representing an impact to a tenant computing system of a security issue instance of a security issue type, the security issue instance arising in a computing component of the tenant computing system, the computer-implemented method comprising: identifying the security issue instance arising in the computing component of the tenant computing system; assigning a component security issue score to the security issue instance, the component security issue score indicating a level of risk of the security issue instance arising from the computing component; retrieving tenant context scores corresponding to other security issue instances of the security issue type historically arising in computing components of a plurality of other tenant computing systems, the tenant context scores representing levels of risk to the plurality of other tenant computing systems by the other security issue instances of the security issue type, the plurality of other tenant computing systems being different from the tenant computing system; determining an imputed tenant context score for the tenant computing system based on the tenant context scores for the plurality of other tenant computing systems; and calculating the system security risk score for the tenant computing system for the security issue instance based on modification of the component security issue score using the imputed tenant context score.
Clause 2. The computer-implemented method of clause 1, further comprising: determining that a computing context of the tenant computing system is unknown, wherein the computing context is determined based on a number of other computing components that are connected to the computing component and security characteristics of the number of other computing components, wherein retrieving, determining, and calculating are performed responsive to determining that the computing context of the tenant computing system is unknown.
Clause 3. The computer-implemented method of clause 1, further comprising: calculating the tenant context scores based on computing contexts of the computing components of the plurality of other tenant computing systems having the other security issue instances, the computing contexts comprising one or more other computing components of the plurality of other tenant computing systems that are connected to the computing components.
Clause 4. The computer-implemented method of clause 3, wherein the one or more other computing components are one or more of logically connected or physically connected to the computing components.
Clause 5. The computer-implemented method of clause 1, wherein the modification of the component security issue score by the imputed tenant context score comprises summing the component security issue score and the imputed tenant context score.
Clause 6. The computer-implemented method of clause 1, wherein the imputed tenant context score is an average of the tenant context scores.
Clause 7. The computer-implemented method of clause 1, further comprising filtering the tenant context scores to yield a set of filtered tenant context scores, wherein filtering the tenant context scores includes removing a proper subset of the tenant context scores determined for the other security issue instances identified for computing components of one or more different component types from a component type of the computing component, wherein the system security risk score is calculated based on the set of filtered tenant context scores.
Clause 8. The computer-implemented method of clause 1, further comprising: filtering the tenant context scores to yield a set of filtered tenant context scores, wherein filtering the tenant context scores comprises removing a proper subset of the tenant context scores corresponding to a proper subset of the plurality of other tenant computing systems of a different type from the tenant computing system, wherein the system security risk score is calculated based on the set of filtered tenant context scores.
Clause 9. One or more tangible processor-readable storage media embodied with instructions for executing on one or more processors and circuits of a computing device a process for generating a system security risk score representing an impact to a tenant computing system of a security issue instance of a security issue type, the security issue instance arising in a computing component of the tenant computing system, the process comprising: identifying a component security issue score corresponding to a security issue instance, the component security issue score indicating a level of risk of the security issue instance arising from the computing component; retrieving tenant context scores corresponding to other security issue instances of the security issue type historically arising in computing components of a plurality of other tenant computing systems, the tenant context scores representing levels of risk to the plurality of other tenant computing systems by the other security issue instances of the security issue type, the plurality of other tenant computing systems being different from the tenant computing system; determining an imputed tenant context score for the tenant computing system based on the tenant context scores for the plurality of other tenant computing systems; and calculating the system security risk score for the tenant computing system for the security issue instance based on modification of the component security issue score using the imputed tenant context score.
Clause 10. The one or more tangible processor-readable storage media of clause 9, the process further comprising calculating the tenant context scores based on computing contexts of the computing components of the plurality of other tenant computing systems having the other security issue instances, the computing contexts comprising one or more other computing components of the plurality of other tenant computing systems that are connected to the computing components.
Clause 11. The one or more tangible processor-readable storage media of clause 10, wherein determining the imputed tenant context score as a function of the tenant context scores.
Clause 12. The one or more tangible processor-readable storage media of clause 9, wherein the modification of the component security issue score by the imputed tenant context score includes summing the component security issue score and the imputed tenant context score.
Clause 13. The one or more tangible processor-readable storage media of clause 9, wherein the imputed tenant context score is an average of the tenant context scores.
Clause 14. The one or more tangible processor-readable storage media of clause 9, the process further comprising filtering the tenant context scores to yield a set of filtered tenant context scores, wherein filtering the tenant context scores includes removing a proper subset of the tenant context scores determined for the other security issue instances identified for computing components of one or more different component types from a component type of the computing component, wherein the system security risk score is calculated based on the set of filtered tenant context scores.
Clause 15. A computing system for generating a system security risk score representing an impact to a tenant computing system of a security issue instance of a security issue type, the security issue instance arising in a computing component of the tenant computing system, the computing system comprising: one or more hardware processors; an issue identifier stored in memory and executable by the one or more hardware processors and configured to identify the security issue instance arising in the computing component of the tenant computing system; a component security issue score calculator stored in memory and executable by the one or more hardware processors and configured to assign a component security issue score to the security issue instance, the component security issue score indicating a level of risk of the security issue instance arising from the computing component; a context adjustment calculator stored in memory and executable by the one or more hardware processors and configured to: calculate tenant context scores corresponding to other security issue instances of the security issue type historically arising in computing components of a plurality of other tenant computing systems based on computing contexts of the computing components of the plurality of other tenant computing systems having the other security issue instances, the computing contexts comprising one or more other computing components of the plurality of other tenant computing systems that are connected to the computing components, the tenant context scores representing levels of risk to the plurality of other tenant computing systems by the other security issue instances of the security issue type, the plurality of other tenant computing systems being different from the tenant computing system; and determine an imputed tenant context score for the tenant computing system based on the tenant context scores for the plurality of other tenant computing systems; and a system security risk score calculator stored in memory and executable by the one or more hardware processors and configured to calculate the system security risk score for the tenant computing system for the security issue instance based on modification of the component security issue score using the imputed tenant context score.
Clause 16. The computing system of clause 15, wherein determining the imputed tenant context score comprises determining the imputed tenant context score as a function of the tenant context scores.
Clause 17. The computing system of clause 15, wherein the one or more other computing components are one or more of logically connected or physically connected to the computing components.
Clause 18. The computing system of clause 15, wherein the modification of the component security issue score by the imputed tenant context score includes summing the component security issue score and the imputed tenant context score.
Clause 19. The computing system of clause 15, wherein the imputed tenant context score is an average of the tenant context scores.
Clause 20. The computing system of clause 15, the context adjustment calculator further configured to filter the tenant context scores to yield a set of filtered tenant context scores, wherein filtering the tenant context scores includes removing a proper subset of the tenant context scores determined for security issues identified for computing components of one or more different computing component types from a computing component type of the computing component, the system security risk score calculator further configured to calculate the system security risk score based on the set of filtered tenant context scores.
Clause 21. A system of generating a system security risk score representing an impact to a tenant computing system of a security issue instance of a security issue type, the security issue instance arising in a computing component of the tenant computing system, the system comprising: means for identifying the security issue instance arising in the computing component of the tenant computing system; assigning a component security issue score to the security issue instance, the component security issue score indicating a level of risk of the security issue instance arising from the computing component; means for retrieving tenant context scores corresponding to other security issue instances of the security issue type historically arising in computing components of a plurality of other tenant computing systems, the tenant context scores representing levels of risk to the plurality of other tenant computing systems by the other security issue instances of the security issue type, the plurality of other tenant computing systems being different from the tenant computing system; means for determining an imputed tenant context score for the tenant computing system based on the tenant context scores for the plurality of other tenant computing systems; and means for calculating the system security risk score for the tenant computing system for the security issue instance based on modification of the component security issue score using the imputed tenant context score.
Clause 22. The system of clause 21, further comprising: means for determining that a computing context of the tenant computing system is unknown, wherein the computing context is determined based on a number of other computing components that are connected to the computing component and security characteristics of the number of other computing components, wherein retrieving, determining, and calculating are performed responsive to determining that the computing context of the tenant computing system is unknown.
Clause 23. The system of clause 21, further comprising: means for calculating the tenant context scores based on computing contexts of the computing components of the plurality of other tenant computing systems having the other security issue instances, the computing contexts comprising one or more other computing components of the plurality of other tenant computing systems that are connected to the computing components.
Clause 24. The system of clause 23, wherein the one or more other computing components are one or more of logically connected or physically connected to the computing components.
Clause 25. The system of clause 21, wherein the modification of the component security issue score by the imputed tenant context score comprises summing the component security issue score and the imputed tenant context score.
Clause 26. The system of clause 21, wherein the imputed tenant context score is an average of the tenant context scores.
Clause 27. The system of clause 21, further comprising means for filtering the tenant context scores to yield a set of filtered tenant context scores, wherein filtering the tenant context scores includes removing a proper subset of the tenant context scores determined for the other security issue instances identified for computing components of one or more different component types from a component type of the computing component, wherein the system security risk score is calculated based on the set of filtered tenant context scores.
Clause 28. The system of clause 21, further comprising: means for filtering the tenant context scores to yield a set of filtered tenant context scores, wherein filtering the tenant context scores comprises removing a proper subset of the tenant context scores corresponding to a proper subset of the plurality of other tenant computing systems of a different type from the tenant computing system, wherein the system security risk score is calculated based on the set of filtered tenant context scores.

Some implementations may comprise an article of manufacture, which excludes software per se. An article of manufacture may comprise a tangible storage medium to store logic and/or data. Examples of a storage medium may include one or more types of computer-readable storage media capable of storing electronic data, including volatile memory or nonvolatile memory, removable or non-removable memory, erasable or non-erasable memory, writeable or re-writeable memory, and so forth. Examples of the logic may include various software elements, such as software components, programs, applications, computer programs, application programs, system programs, machine programs, operating system software, middleware, firmware, software modules, routines, subroutines, operation segments, methods, procedures, software interfaces, application program interfaces (API), instruction sets, computing code, computer code, code segments, computer code segments, words, values, symbols, or any combination thereof. In one implementation, for example, an article of manufacture may store executable computer program instructions that, when executed by a computer, cause the computer to perform methods and/or operations in accordance with the described embodiments. The executable computer program instructions may include any suitable types of code, such as source code, compiled code, interpreted code, executable code, static code, dynamic code, and the like. The executable computer program instructions may be implemented according to a predefined computer language, manner, or syntax, for instructing a computer to perform a certain operation segment. The instructions may be implemented using any suitable high-level, low-level, object-oriented, visual, compiled, and/or interpreted programming language.

The implementations described herein are implemented as logical steps in one or more computer systems. The logical operations may be implemented (1) as a sequence of processor-implemented steps executing in one or more computer systems and (2) as interconnected machine or circuit modules within one or more computer systems. The implementation is a matter of choice, dependent on the performance requirements of the computer system being utilized. Accordingly, the logical operations making up the implementations described herein are referred to variously as operations, steps, objects, or modules. Furthermore, it should be understood that logical operations may be performed in any order, unless explicitly claimed otherwise or a specific order is inherently necessitated by the claim language.

What is claimed is:

1. A computer-implemented method of generating a system security risk score representing an impact to a tenant computing system of a security issue instance of a security issue type, the security issue instance arising in a computing component of the tenant computing system, the computer-implemented method comprising:
identifying the security issue instance arising in the computing component of the tenant computing system;
assigning a component security issue score to the security issue instance, the component security issue score indicating a level of risk of the security issue instance arising from the computing component;
retrieving tenant context scores corresponding to other security issue instances of the security issue type historically arising in computing components of a plurality of other tenant computing systems, the tenant context scores representing levels of risk to the plurality of other tenant computing systems by the other security issue instances of the security issue type, the plurality of other tenant computing systems being different from the tenant computing system;
determining an imputed tenant context score for the tenant computing system based on the tenant context scores for the plurality of other tenant computing systems; and
calculating the system security risk score for the tenant computing system for the security issue instance based on modification of the component security issue score using the imputed tenant context score.

2. The computer-implemented method of claim 1, further comprising:
determining that a computing context of the tenant computing system is unknown, wherein the computing context is determined based on a number of other computing components that are connected to the computing component and security characteristics of the number of other computing components, wherein retrieving, determining, and calculating are performed responsive to determining that the computing context of the tenant computing system is unknown.

3. The computer-implemented method of claim 1, further comprising:
calculating the tenant context scores based on computing contexts of the computing components of the plurality of other tenant computing systems having the other security issue instances, the computing contexts comprising one or more other computing components of the plurality of other tenant computing systems that are connected to the computing components.

4. The computer-implemented method of claim 3, wherein the one or more other computing components are one or more of logically connected or physically connected to the computing components.

5. The computer-implemented method of claim 1, wherein the modification of the component security issue score by the imputed tenant context score comprises summing the component security issue score and the imputed tenant context score.

6. The computer-implemented method of claim 1, wherein the imputed tenant context score is an average of the tenant context scores.

7. The computer-implemented method of claim 1, further comprising filtering the tenant context scores to yield a set of filtered tenant context scores, wherein filtering the tenant context scores includes removing a proper subset of the tenant context scores determined for the other security issue instances identified for computing components of one or more different component types from a component type of the computing component, wherein the system security risk score is calculated based on the set of filtered tenant context scores.

8. The computer-implemented method of claim 1, further comprising:
filtering the tenant context scores to yield a set of filtered tenant context scores, wherein filtering the tenant context scores comprises removing a proper subset of the tenant context scores corresponding to a proper subset of the plurality of other tenant computing systems of a different type from the tenant computing system, wherein the system security risk score is calculated based on the set of filtered tenant context scores.

9. One or more tangible processor-readable storage media embodied with instructions for executing on one or more processors and circuits of a computing device a process for generating a system security risk score representing an impact to a tenant computing system of a security issue instance of a security issue type, the security issue instance arising in a computing component of the tenant computing system, the process comprising:
identifying a component security issue score corresponding to a security issue instance, the component security issue score indicating a level of risk of the security issue instance arising from the computing component;
retrieving tenant context scores corresponding to other security issue instances of the security issue type historically arising in computing components of a plurality of other tenant computing systems, the tenant context scores representing levels of risk to the plurality of other tenant computing systems by the other security issue instances of the security issue type, the plurality of other tenant computing systems being different from the tenant computing system;
determining an imputed tenant context score for the tenant computing system based on the tenant context scores for the plurality of other tenant computing systems; and
calculating the system security risk score for the tenant computing system for the security issue instance based on modification of the component security issue score using the imputed tenant context score.

10. The one or more tangible processor-readable storage media of claim 9, the process further comprising calculating the tenant context scores based on computing contexts of the computing components of the plurality of other tenant computing systems having the other security issue instances, the computing contexts comprising one or more other computing components of the plurality of other tenant computing systems that are connected to the computing components.

11. The one or more tangible processor-readable storage media of claim 10, wherein determining the imputed tenant context score as a function of the tenant context scores.

12. The one or more tangible processor-readable storage media of claim 9, wherein the modification of the component security issue score by the imputed tenant context score includes summing the component security issue score and the imputed tenant context score.

13. The one or more tangible processor-readable storage media of claim 9, wherein the imputed tenant context score is an average of the tenant context scores.

14. The one or more tangible processor-readable storage media of claim 9, the process further comprising filtering the tenant context scores to yield a set of filtered tenant context scores, wherein filtering the tenant context scores includes removing a proper subset of the tenant context scores determined for the other security issue instances identified for computing components of one or more different component types from a component type of the computing component, wherein the system security risk score is calculated based on the set of filtered tenant context scores.

15. A computing system for generating a system security risk score representing an impact to a tenant computing system of a security issue instance of a security issue type, the security issue instance arising in a computing component of the tenant computing system, the computing system comprising:
one or more hardware processors;
an issue identifier stored in memory and executable by the one or more hardware processors and configured to identify the security issue instance arising in the computing component of the tenant computing system;
a component security issue score calculator stored in memory and executable by the one or more hardware processors and configured to assign a component security issue score to the security issue instance, the component security issue score indicating a level of risk of the security issue instance arising from the computing component;
a context adjustment calculator stored in memory and executable by the one or more hardware processors and configured to:
calculate tenant context scores corresponding to other security issue instances of the security issue type historically arising in computing components of a plurality of other tenant computing systems based on computing contexts of the computing components of the plurality of other tenant computing systems having the other security issue instances, the computing contexts comprising one or more other computing components of the plurality of other tenant computing systems that are connected to the computing components, the tenant context scores representing levels of risk to the plurality of other tenant computing systems by the other security issue instances of the security issue type, the plurality of other tenant computing systems being different from the tenant computing system; and
determine an imputed tenant context score for the tenant computing system based on the tenant context scores for the plurality of other tenant computing systems; and
a system security risk score calculator stored in memory and executable by the one or more hardware processors and configured to calculate the system security risk score for the tenant computing system for the security issue instance based on modification of the component security issue score using the imputed tenant context score.

16. The computing system of claim 15, wherein determining the imputed tenant context score comprises determining the imputed tenant context score as a function of the tenant context scores.

17. The computing system of claim 15, wherein the one or more other computing components are one or more of logically connected or physically connected to the computing components.

18. The computing system of claim 15, wherein the modification of the component security issue score by the imputed tenant context score includes summing the component security issue score and the imputed tenant context score.

19. The computing system of claim 15, wherein the imputed tenant context score is an average of the tenant context scores.

20. The computing system of claim 15, the context adjustment calculator further configured to filter the tenant context scores to yield a set of filtered tenant context scores, wherein filtering the tenant context scores includes removing a proper subset of the tenant context scores determined for security issues identified for computing components of one or more different computing component types from a computing component type of the computing component, the system security risk score calculator further configured to calculate the system security risk score based on the set of filtered tenant context scores.
